(19) United States
(12) Patent Application Publication
(10) Pub. No.: US 2004/0205718 A1
(43) Pub. Date: Oct. 14, 2004

(54) Self-tuning object libraries

(75) Inventor: John V.W. Reynders, Newton, MA (US)

Correspondence Address: FOLEY HOAG, LLP, PATENT GROUP, WORLD TRADE CENTER WEST, 155 SEAPORT BLVD, BOSTON, MA, 02110, US

(73) Assignee: SUN MICROSYSTEMS, INC.

(21) Appl. No.: 09/734,388

(22) Filed: Dec. 11, 2000

(51) Int. Cl. G06F 9/44; G06F 9/45

(52) U.S. Cl. 717/124; 717/128

(57) ABSTRACT

Self-tuning objects for developing programs to be executed on parallel computers. A trace file reflecting the sequence of expressions in a user program that include the self-tuning objects is generated during simulation. The trace file is divided into trace file blocks such that data and computational dependencies between trace blocks is minimized. The trace file blocks are converted into source code expression blocks, which are each parameterized to reflect a number of conventional compiler optimization techniques. Various optimization parameter values are applied to the expression blocks to generate minimal timing, compiled versions. The minimal timing compilations of the expression blocks are linked into the user program and executed in response to detection of self-tuning object expressions in the user code. The minimal timing compilations are then mapped to processors within the target parallel computer system for execution.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

The present invention relates generally to software for parallel processing computer systems, and more specifically to a system and method for providing self tuning object libraries for use in a computer software program designed for parallel execution.

As it is generally known, a parallel computer typically includes multiple processors that are able to work cooperatively to solve a computational problem. Specific types of parallel computers include parallel supercomputers having hundreds or thousands of processors, networks of workstations, and multi-processor workstations. Parallel computers offer the potential to concentrate computational resources, such as processors, memory, or I/O bandwidth, on difficult computational problems.

Various types of parallel computer architectures have been developed. Multiple instruction multiple data (MIMD) parallel computers are designed such that each processor can execute a separate instruction stream on its own local data. Distributed-memory MIMD (multiple instruction multiple data) computers are designed such that memory is distributed across the processors, rather than placed in a central location. Some examples of distributed-memory MIMD computers include the IBM SP and Intel Paragon. In shared-memory MIMD computers, all processors share access to a common memory, typically via a bus or a hierarchy of buses. While ideally, any processor in such a shared-memory design can access any memory element in the same amount of time, scaling of this architecture usually introduces some form of memory hierarchy. Accordingly, differences between shared memory and distributed memory parallel computer architectures are often only a matter of degree. Examples of shared memory parallel computer architectures include the Silicon Graphics Challenge, Sequent Symmetry, and many multiprocessor workstations.

Single Instruction Multiple Data (SIMD) parallel computers include multiple processors which execute the same instruction stream on different pieces of data. The SIMD approach is often appropriate for specialized problems characterized by a high degree of regularity, such as image processing. The MasPar MP is an example of this class of machine. Multiple computers interconnected by a network, such as a local area network (LANs) or wide area network (WAN), may also be used as a parallel computer system.

Various programming models have been used to describe programs designed for execution on parallel computers. For example, a parallel computation may be described as consisting of one or more tasks, each of which encapsulates a sequential program and local memory, and which may execute concurrently with other tasks. A task can read and write its local memory, and send messages to other tasks. This type of model is sometimes referred to as a message passing system. Some message-passing systems operate by creating a fixed number of identical tasks at program startup and do not allow tasks to be created or destroyed during program execution. These systems are said to implement a single program multiple data (SPMD) programming model because each task executes the same program but operates on different data.

Another commonly used parallel programming model, data parallelism, calls for exploitation of the concurrency that derives from the application of the same operation to multiple elements of a data structure. Accordingly, a “data parallel” data object typically includes a data structure whose elements can be operated on simultaneously, as needed. Accordingly, the methods, functions, and/or overloaded operators associated with a data parallel data object may be used to encapsulate the decomposition of certain program steps into tasks which may be executed in parallel on different elements of the data parallel object.

The term “partitioning” is generally used to refer to the process of determining opportunities for parallel execution within a program to be executed on a parallel computer. For example, partitioning may involve dividing both the computation associated with a problem and the data on which this computation operates into a number of subsets which may, for example, be referred to as tasks or blocks. Partitioning is referred to as “domain decomposition” when it focuses primarily on the data associated with a problem, in order to determine an appropriate partition for the data. When the partitioning process focuses on the computation to be performed, it is considered to be termed “functional decomposition.”

There has been an increasing body of research in the development of object-based and object-oriented libraries for the development of software applications that will exploit the processing capabilities of parallel computers such as multiprocessor supercomputers. The motivation for these efforts has been a desire to enable an application developer to design programs without having to consider the ever increasing levels of supercomputer architectural complexity. In particular, existing systems have provided an object interface that encapsulates the parallel programming details related to the specific design of a target parallel computer hardware platform. These existing object libraries are typically cast in C++ or Fortran 90 in order to leverage the core software environments of computer vendors. Existing approaches to encapsulation of parallel programming details through specialized languages such the Zebra Programming Language (ZPL®) provided by the Zebra Technologies Corporation, or High Performance Fortran (HPF), or through language extensions such as CHARM and CC++, have not had significant success in the academic, government, or industrial high-performance computing communities due to their lack of standardization and limitations on their performance. Existing object libraries, built upon standard Fortran 90 and C++ compiler/tool sets, have seen only modest success in encapsulating the increasing architectural complexities of parallel computers while concomitantly providing the user with an application-domain relevant set of abstractions (e.g., arrays, matrices, point distributions) which ease the code development process.

Moreover, such existing object libraries are falling behind in their ability to provide sufficient application performance. In particular, the increasing levels of memory hierarchies in clustered shared-memory-processor (SMP) supercomputers requires these libraries to move towards a mixed model of inter-SMP message passing and intra-SMP multi-threaded programming while optimizing for load- balance, message-traffic, and processor-memory affinity. Although combinations of compile-time and run-time systems have been able to build libraries that satisfy correctness with modest scalability, existing systems have failed to provide high performance.

For example, existing object libraries typically contain data-parallel objects, such as arrays or other application relevant abstractions, which the programmer can utilize to write high-level data parallel expressions. For the purposes herein, data parallel expressions may be considered any expression including at least one reference to a data parallel object. The following is an illustrative data parallel expression using data parallel array objects A and B:

A[I][J]=B[I+1][J]+B[I−1][J]+B[I][J+1]+B[I][J−1];

Arrays A and B could be very large arrays loaded into memory which may be distributed across and/or shared by hundreds of processors. Through compilation and run-time techniques, arrays A and B communicate between one another to perform the operations specified in the expression. Two techniques used in existing C++-based systems to improve the performance of data-parallel expressions, such as the expression above, are semantic in-lining and expression templates.

As will be recognized by those skilled in the art, the above data parallel expression would result in successive execution of functions defined by the overloaded operator “+” symbol, which would be associated with the type of the data parallel arrays A and B. Semantic in-lining based techniques recognize a predefined expression as a whole, at run-time, and call an associated user-supplied, predefined routine rather than execute successive overloaded operator function calls. Semantic in-lining provides a significant increase in speed. However, the user must provide a library of callable routines ahead of time corresponding to the expressions used by the application.

Expression template techniques in C++ operate at compile time to form object types for each unique expression through recursive parsing of an expression tree derived from the expression. Given an efficient C++ compiler capable of aggressive compiler in-lining, each expression is reduced to a single for-loop for each expression rather than a sequence of overloaded operator calls. A significant drawback of expression templates, however, is excessive compilation time.

Both expression templates and semantic in-lining provide only partial solutions to the optimization of single expression statements in a data-parallel context. Due to the inability of expression templates and semantic in-lining to enable optimizations across multiple expressions, the performance gains provided by these techniques are undesirably limited. Moreover, per expression array optimization often limits the application of many conventional compiler optimization techniques, such as software pipelining, loop unrolling, and cache block optimization, across expressions.

Furthermore, certain parameters of optimization cannot be known at compile time. For example, parameters of many conventional optimization techniques, such as the optimal data or array blocking factors, loop unrolling levels, and pre-fetching hints are typically not available for a given user-defined program until run time. These factors also have a highly interdependent, and at times highly unintuitive nature that further complicates attempts at optimization.

Recent work in the area of Fast Fourier Transform (FFT) programming and Basic Linear Algebra Subprograms (BLAS) have shown significant performance improvements through the development of self-tuning techniques wherein a single, known algorithm is cast into a set of source code routines which are each compiled and timed over a set of conventional optimization parameters including blocking factors, unrolling levels, and pre-fetching radii. An example of such FFT work is the software developed at the Massachusetts Institute of Technology by Matteo Frigo and Steven G. Johnson, and referred to as the “Fastest Fourier Transform in the West” (FFTW). An example of such BLAS work is the software developed by R. Clint Whaley and Jack Dongarra at the University of Tennessee and the Oak Ridge National Laboratory, and referred to as the “Automatically Tuned Linear Algebra Software” (ATLAS) libraries. In these systems, based upon a compiled timing database, the optimal source routines are stitched together and comprise the optimal library routine for the target architecture. However, these existing techniques provide only off-line optimization of individual, predefined algorithms, and provide no generalized assistance to a programmer with regard to new parallel program development. Moreover, they do not provide a generic system, which would assist a user in developing a user defined algorithm or program by providing the benefits of self tuning.

For the reasons stated above, it would therefore be desirable to have a system which provides users with a more general tool for developing programs to be executed on a parallel computer such as a multi-processor supercomputer. In particular, it would be desirable to have a system which provides a high-level parallel object library that is able to self-tune user-defined object operations specified in an array language to a target parallel architecture. The system should be applicable to programs written for various parallel computer architectures, such as MIMD and/or SIMD computers, distributed and/or shared memory computers, and/or multiple computers interconnected by a network. Further, the system should be applicable to various parallel programming models, including data parallelism and/or message passing.

### BRIEF SUMMARY OF THE INVENTION

In accordance with the present invention, a system and method for providing self-tuning objects are disclosed. The disclosed system and method may be applied to any specific type of object used to develop programs for execution on parallel computers. As disclosed herein, a record of operations manipulating the self-tuning objects is generated as those operations are being performed. This record of operations is subsequently used to generate source code blocks that are parameterized and optimized based on a number of conventional optimization techniques. While some of the disclosed embodiments may be described as self-tuning data parallel objects, the disclosed system is applicable to other parallel processing models as well.

In an illustrative embodiment, the disclosed system first receives a user program. Processing of the user program by the disclosed system may be triggered by a compilation step initiated by the program developer, or at run time when the program is executed. A simulation step is performed in which a number of trace files are generated. As the simulation executes, occurrences of expressions using the self-tuning objects are detected and recorded in the trace files. Accordingly, the generated trace files define the sequence in which expressions using the self-tuning objects occurred in the program during the simulation. Detection of occurrences of expressions using the self-tuning objects may, for example, be performed through over-loaded operators associated with the object types of the self-tuning objects. Alternatively, functions or methods associated with the self-tuning objects may be used to detect the occurrence of expressions using the self-tuning objects in order to build the trace files.

The trace files generated during the above described simulation are stored using an intermediate form. Any specific intermediate form may be employed in this regard, so long as the trace files reflect the execution flow of the user program during the simulation. The intermediate form should enable generation of procedural source code statements equivalent to the expressions using the self-tuning objects that were detected during the simulation.

The trace file or files are divided into blocks during the simulation step. These trace file blocks may simply represent sets of sequential expressions. The specific borders between the trace file blocks are determined so as to minimize data and computational dependencies both between the trace file blocks and in the aggregate. Alternatively, or in addition, the user may explicitly specify regions of simulation where self-tuning objects are to activate and de-activate, thus defining the borders between trace file blocks, and potentially reducing the overall complexity of the analysis. Such explicit specification may be provided as any type of convenient delimiter defined for this purpose within the user program. Data values used during the simulation step may be obtained from target data files available at run time, or as indicated by the program developer for simulation use during compile time.

Following generation of the trace file blocks in the simulation step, a parameterization and optimization step is performed. During this step, the trace file blocks are first converted into source code, such as C or Fortran. These converted trace file blocks are referred to herein, for purposes of illustration, as expression blocks. Each of the expression blocks is then parameterized to reflect various conventional optimization techniques. A number of alternative optimization parameter values are generated for each optimization parameter of each expression block. Each expression block is then compiled, run, and timed using various combinations of the optimization parameter values.

A linking step is then performed during which the minimal timing, compiled expression blocks into the user program, for example through the symbol table generated during the simulation step. Accordingly, as the user program executes, the expressions using the self-tuning objects are again detected, for example, responsive to the use of associated overloaded operators, and/or associated function or method calls. The detected expressions are matched against the symbols corresponding to the minimal timing, compiled expression blocks using the symbol table initially generated during the simulation step. Constructing a common hash-table lookup where a hash key is distilled for each expression in the trace file accelerates expression matching. The minimal timing, compiled expression blocks are then scheduled for execution by mapping to specific processors of the target parallel processing computer system. As the minimal timing, compiled expression blocks execute, data and computational dependencies are tracked, and processor mapping of the minimal timing, compiled expression blocks is adjusted to improve such dependencies as may be possible.

The disclosed system differs from previous work in its deployment of a self-tuning mechanism within a class library wherein the optimization combinatorics are constrained to the set of operations which can be performed by the library (e.g. math operations, indexing, and reduction). This enables the distillation of a closed intermediate form and a basis for automatic code generation and parameterized optimization. Furthermore, the disclosed system of self-tuning objects is conveniently applicable to user-defined algorithms as opposed to only fixed procedural algorithms. In particular, automated self-tuning techniques have not been applied to parallel object libraries.

### BRIEF DESCRIPTION OF THE SEVERAL VIEWS OF THE DRAWING

The invention will be more fully understood by reference to the following detailed description of the invention in conjunction with the drawings, of which:

FIG. 1 is a flow chart showing steps performed in connection with an illustrative embodiment of the disclosed system;

FIG. 2 shows software components operating in connection with an illustrative embodiment; and

FIG. 3 further illustrates operation of an illustrative embodiment, showing advantageous results thereby obtained.

### DETAILED DESCRIPTION OF THE INVENTION

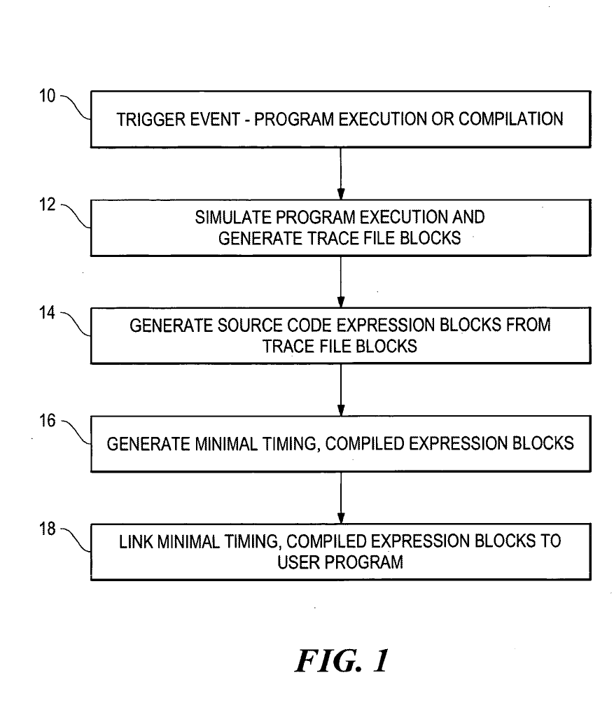

The disclosed system operates to provide a self-tuning object library to a user program. As illustrated in the flow chart of FIG. 1, an embodiment of the disclosed system is triggered at step 10 by a trigger event. Trigger events detected at step 10 may include execution of the user program, and/or compilation of the user program. Accordingly, the developer of the user program may initiate operation of the disclosed system either through a compilation step, or by running the program.

In response to the triggering event at step 10, at step 12 the disclosed system simulates execution of the user program. While execution of the user program is being simulated at step 12, a record of operations manipulating instances of the self-tuning objects is generated as those operations are simulated. More specifically, as the simulation is performed, occurrences of expressions using the self-tuning objects are detected and recorded into a number of trace files. The trace files thereby generated define the sequence in which expressions using the self-tuning objects occur in the program during the simulation. Detection of occurrences of expressions using the self-tuning objects may, for example, be performed through over-loaded operators associated with the object types of the self-tuning objects. Alternatively, functions or methods associated with the self-tuning objects may be used to detect the occurrence of expressions using the self-tuning objects in order to build the trace files.

The trace files generated during step 12 of FIG. 1 are stored using an intermediate form. Any specific intermediate form may be employed in this regard, so long as the trace files reflect the execution flow of the user program during the simulation. The intermediate form should enable generation of procedural source code statements equivalent to the expressions using the self-tuning objects that were detected during the simulation.

For example, an illustrative trace file symbol table schema containing the necessary information for generating source is as follows:

I. An Objects Table, into which a new entry is inserted on each object instantiation during the simulation of step 12 in FIG. 1:

| Object_ID | \| | Object_Name | \| | Layout_ID |
|---|---|---|---|---|
| 1 | \| | A | \| | 1 |
| 2 | \| | B | \| | 1 |
| 3 | \| | C | \| | 1 |
| 4 | \| | D | \| | 1 |

II. A Layouts Table. As it is generally known, a “layout” in the present context is a term used in computer science to refer to a description of how the data in an object is distributed across the memories in a parallel computer. Accordingly, a “layout instantiation” within the simulation step 12 of FIG. 1 is the creation by the user program during the simulation step of a new layout definition which can be utilized by Array objects to describe their parallel data distributions. A new entry is inserted into the Layouts Table upon each layout instantiation detected during simulation of the user program:

| | | | | | | | | |
|---|---|---|---|---|---|---|---|---|
| Layout_ID | \| | dimension1 | \| | dimension2 | \| | dimension3 | \| | . . . |

| | | | | | |
|---|---|---|---|---|---|
| 1 | \| | 1000 | \| | 1000 | \| |

With the above schema, where A, B, C and D are each instances of a self tuning, two dimensional parallel array object provided by the disclosed system, in the case where the following three expressions were encountered during the simulation performed in step 12 of FIG. 1:

A[I][J]=B[I+1][J]+B[I−1][J];

C[I][J]=A[I][J+1]−A[I][J−1];

D[I][J]=C[I+1][J+1]+B[I−1][J−1];

a possible trace file output might be

1<1>(0,0)=2<1>(1,0)+2<1>(−1,0)

3<1>(0,0)=1<1>(0,1)−1<1>(0,−1)

4<1>(0,0)=3<1>(1,1)+2<1>(−1,−1)

where the term in front of the first angle bracket represents the Object_ID, the term between angle brackets represents the Layout_ID, and the terms between the parentheses represent the index offsets, and where each line in the trace file output corresponds to an expression in the user program.

Further in step 12, the trace file or files are divided into trace file blocks. The trace file blocks represent sets of sequential expressions detected during simulation. The specific borders between the trace file blocks within the trace files are determined so as to minimize data and computational dependencies between trace file blocks. The user may also explicitly specify regions of simulation where self-tuning objects are to activate and de-activate, thus potentially defining the borders between trace file blocks, and reducing the complexity of the overall analysis performed. Data values used during the simulation performed in step 12 may be obtained from target data files available to the user program at run time, or as indicated by the program developer for simulation use during compile time.

Following generation of the trace file blocks in the simulation step, parameterization and optimization of the trace file blocks are performed. At step 14, the disclosed system converts the trace file blocks into source code, such as C or Fortran. The trace file blocks that have been converted into source code are referred to herein, for purposes of illustration, as expression blocks. At step 16, each of the expression blocks is parameterized to reflect various conventional optimization techniques. During the parameterization performed at step 16, the source code generated for each expression block is embedded with parameters for each optimization technique to be applied, thus allowing variation of the parameter values for each particular optimization technique. For example, a parameter for loop unrolling would be an integer specifying the number of times the source code within the expression block should be unrolled, whereas a parameter for blocking would be an integer specifying the number of blocks into which a region of memory used by the expression block is to be subdivided.

A number of alternative optimization parameter values are generated for each optimization parameter of each expression block. Each expression block is then compiled, run and timed using various combinations of the optimization parameter values, in order to find those optimization parameter values resulting in a minimal timing, compiled version for each of the expression blocks.

Various appropriate conventional optimization techniques may be applied during step 16 of FIG. 1 to determine the minimal timing, compiled expression blocks. For purposes of illustration, several possible conventional optimization techniques which may be applied at step 16 are now mentioned briefly: Domain-decomposition may be applied to the expression blocks to provide optimal communication to computation ratios. Latency management may be applied to the expression blocks to reduce contention on the interconnect of the target parallel processing computer. Blocking optimization may be used to improve memory locality. Memory utilization may be improved at all levels of the target system memory hierarchy through application of data compression. Loop unrolling may be used to improve instruction-level parallelism. Coloring may be used to increase utilization in associative memory systems. Memory Clustering may be used to improve temporal locality, and/or pre-fetching may be optimized to maintain throughput in pipelined systems.

At step 18, linking is performed to link the minimal timing, compiled expression blocks are linked into the user program, for example through the symbol table generated during the simulation performed in step 12. Accordingly, at step 18, as the user program executes, the expressions using the self-tuning objects are again detected, for example, responsive to the overloaded operators, and/or function or method calls associated with the self-tuning objects. The detected expressions are matched against the symbols corresponding to the minimal timing, compiled expression blocks using the symbol table initially generated during the simulation step. In this way, a given minimum timing expression block may be linked (perhaps dynamically) into the user program to provide optimized execution for the multiple expressions in the corresponding user-defined expression block in the original source. In an illustrative embodiment, a common hash-table lookup is constructed in which a hash key is distilled for each expression in the trace file in order to accelerate matching of an expression detected during program execution to the appropriate minimal timing, compiled expression block. The minimal timing, compiled expression blocks are then scheduled for execution by mapping to specific processors of the target parallel processing computer system. As the minimal timing, compiled expression blocks execute, data and computational dependencies are tracked, and processor mapping of the minimal timing, compiled expression blocks may be adjusted to improve such dependencies.

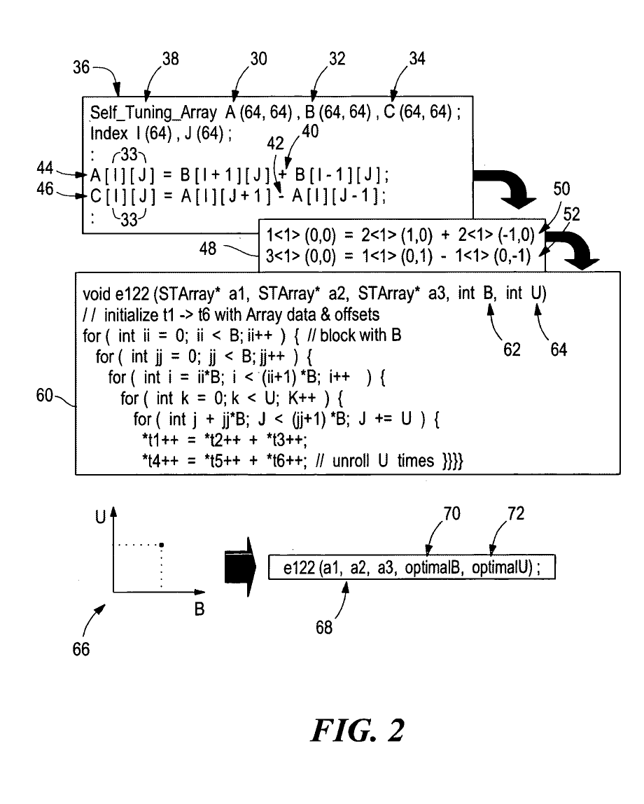

As shown in the illustrative embodiment of FIG. 2, the self-tuning objects A 30, B 32 and C 34 in the user program 36 are instances of the Self_Tuning_Array type 38 from a library of data-parallel array object classes that are instrumented with over-loaded operators. For example, the “+” operator 40 and “−” operator 42 in the expressions 44 and 46 are overloaded operators whose specific operation is defined in association with the Self_Tuning_Array type 38. The user program may include looping expressions, such as “for” loops, which iterate through the values of the indexes I and J for self-tuning objects A 30, B 32 and C 34. In other words, as shown in FIG. 2, the Index objects I and J 33 are used to represent data-parallel operations across all the data in each respective one of the self-tuning objects A 30, B 32, and C 34 in the expressions 44 and 46. Thus the user program 36 is shown utilizing the self-tuning array objects 30, 32, and 34 in expressions 44 and 46 with overloaded operators and index objects.

During the simulation step 12 as shown in FIG. 1, the code associated with the over-loaded operators 40 and 42 emits the intermediate form representation of the expressions 44 and 46 into the trace file 48. The trace file 48 defines the sequence of expressions that use the data-parallel array objects 30, 32 and 34 in the user program 36. As previously described above, the array object library also emits array object IDs into a symbol table during the simulation step in order to match data to operations. As shown in FIG. 2, the trace file 48 includes a line 50 corresponding to the expression 44 in the user program 36, and a line 52 corresponding to the expression 46 in the user program 36. The syntax of the trace file is, for purposes of illustration, the same as described above in connection with generation of the symbol table during step 12 of FIG. 1. Further for purposes of illustration, the lines 50 and 52 of the trace file 48 make up a single trace file block.

Subsequent to generation of the trace file 48, the trace file blocks are converted to source code expression blocks, and relevant optimizations are selected for application to the expression blocks. As shown in FIG. 2, blocking and loop unrolling are examples of optimization which may be selected and applied to the expression blocks. The expression blocks are then parameterized to reflect parameters associated with the relevant optimizations. As shown in FIG. 2, parameterized source code 60 is generated for the expression block consisting of lines 50 and 52 within the trace file 48. The parameterized source code 60 is shown including parameters B 62 and U 64, which allow various levels of blocking and loop unrolling to be applied to the expression block, in order to determine the optimal blocking and loop unrolling levels. Accordingly, the parameterized source code 60 can be compiled and timed using various blocking and loop unrolling levels by varying the values of B 62 and U 64. The resulting timings can be used to search for optimal values for B 62 and U 64, as shown by graph 66. In this way the parameterized source code is compiled and run across the optimization parameter space and optimal parameter values are determined. Such optimal values (optimalB 70 and optimalU 72) are then used to generate the compiled version of the parameterized source code 60 that is linked into the user program, as illustrated by the call 68 to the parameterized source code 60 using optimalB 70 and optimalU 72.

Further in an illustrative embodiment, rather than execute and time all compiled versions of the expression blocks that would result from all combinations of possible optimization parameter values, an intelligent search algorithm may be used to identify the optimization parameters resulting in the minimal timing, compiled version of each expression block. For example, in the case where the parameterized source code for an expression block uses six optimization parameters, the time required to exhaustively search every point on a 6-dimensional mesh of a specified granularity could be prohibitively costly. Instead, in an illustrative embodiment, a steepest-gradient, Newton-iteration, or genetic search technique may be applied to more rapidly converge to a promising optimization. For exceptionally large dimensional searches, low-discrepancy point-set Monte-Carlo techniques may be applied to obtain a better sampling of high-dimensional spaces.

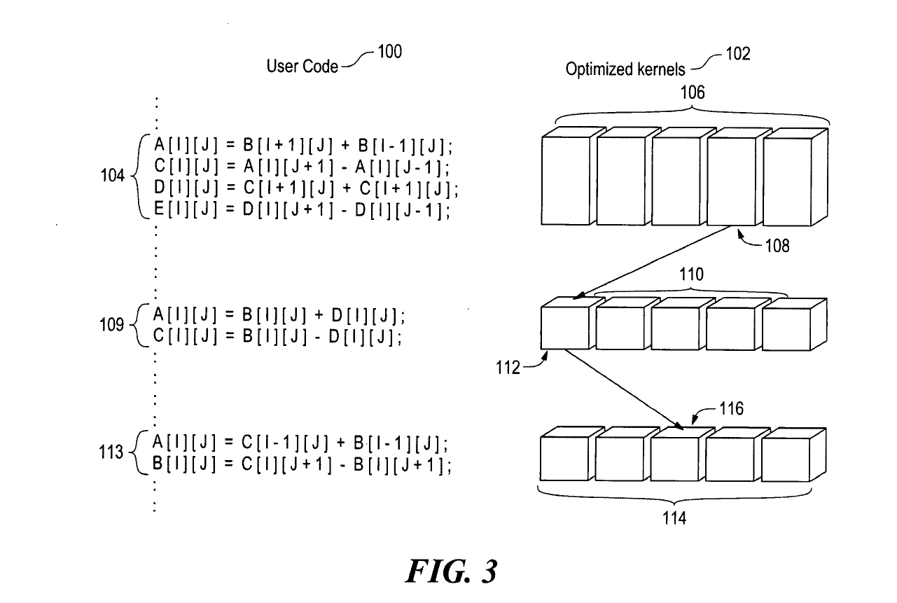

FIG. 3 illustrates how the disclosed system operates to independently determine the optimal parameters for optimization of each expression block. As shown in FIG. 3, a user program 100 is shown including expressions in groups corresponding to expression blocks obtained by the disclosed system. The expressions in the user program 100 are part of a larger portion of user program source code. The expressions are comprised of the disclosed self-tuning array objects and their defined operators. Sets of compiled and optimized kernels 102 are generated by the disclosed system for each expression block. In particular, the set of optimized kernels 106 is generated based on various optimization parameter values applied to the expression block for the group of expressions 104. Similarly, the group of optimized kernels 110 is generated based on various optimization parameter values applied to the expression block for the group of expressions 109. Also, the group of optimized kernels 114 is generated based on various optimization parameter values applied to the expression block for the group of expressions 113.

Further as shown in FIG. 3, an optimal one of the optimized kernels 102 is independently selected for each of the expression blocks of the groups of expressions. Specifically, the optimized kernel 108 is selected as the optimal one of the optimized kernels 106, the optimized kernel 112 is selected as the optimal one of the optimized kernels 110, and the optimized kernel 116 is selected as the optimal one of the optimized kernels 114. The optimal one of each group of optimized kernels may be selected, for example, based on minimal execution timing. Accordingly, the optimization parameter values for each of the selected optimal kernels 108, 112 and 116 are independent from one another. Moreover, the types of optimizations applied to determine the set of optimized kernels for each expression block may vary across expression blocks. In this way, each expression block may be compiled, run, and timed using varying values for a number of optimization parameters. Further as shown in FIG. 3, the minimal timing optimized kernels 108, 112 and 116 are linked back into the user code 100 and invoked at each occurrence of the corresponding expression block in the user code 100.

The disclosed system differs from previous work in its deployment of a self-tuning mechanism within a class library wherein the optimization combinatorics are constrained to the set of operations which can be performed by the library (e.g. math operations, indexing, and reduction). This enables the distillation of a closed intermediate form and a basis for automatic code generation and parameterized optimization. Furthermore, the disclosed system of self-tuning objects is conveniently applicable to user-defined algorithms as opposed to only fixed procedural algorithms. In particular, automated self-tuning techniques have not been applied to parallel array libraries.

The disclosed system may be embodied within an object class library that includes a debugging mode wherein overloaded operators associated with the self-tuning objects concurrently perform simple low-performance operations on the data while emitting the necessary trace information. Thus, users may interact with and debug a user program without having to penetrate into the expression blocks. Furthermore, a user may start a simulation that spawns separate processes that accept the emitted traces, generate the -minimal timing, compile expression blocks, and then dynamically link the tuned library into the running code, thus enabling round-trip optimization within a single run.

The disclosed system is not specific to a particular programming language. It can enable arrays libraries with overloaded operators in C++, Fortran, and ADA. It can also enable array libraries in other languages, such a Java, by building applications with Java objects that emit an acceptable intermediate form to the parameterization and optimization step. The system disclosed is also not limited to programs designed for a specific parallel computer architecture, and is applicable to various parallel computer architectures, such as MIMD and/or SIMD computers, distributed and/or shared memory computers, and/or multiple computers interconnected by a network. The disclosed system is applicable to various parallel programming models, including data parallelism and/or message passing.

Those skilled in the art should readily appreciate that the programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using baseband signaling or broadband signaling techniques, including carrier wave signaling techniques, such as over computer or telephone networks via a modem. In addition, while the invention may be embodied in computer software, the functions necessary to implement the invention may alternatively be embodied in part or in whole using hardware components such as Application Specific Integrated Circuits or other hardware, or some combination of hardware components and software.

While the invention is described through the above exemplary embodiments, it will be understood by those of ordinary skill in the art that modification to and variation of the illustrated embodiments may be made without departing from the inventive concepts herein disclosed. Specifically, while the preferred embodiments are disclosed with reference to several illustrative optimization techniques, the present invention is generally applicable to any optimization technique which can be applied to a computer program. Moreover, while the preferred embodiments are described in connection with various illustrative object types, one skilled in the art will recognize that the system may be embodied using a variety of specific object types. Accordingly, the invention should not be viewed as limited except by the scope and spirit of the appended claims.

1. A method for providing at least one self-tuning object to a user program, the method comprising:
receiving said user program;
simulating execution of said user program;
detecting, during said simulation of said execution of said user program, occurrences of expressions using said at least one self-tuning object in said user program,
generating, for each occurrence, in response to said detecting, an entry in a trace file including data representing said expressions and reflecting an execution flow of said expressions in said user program during said simulating and enabling generation of source code corresponding to said expressions;
dividing said trace file into a plurality of trace file blocks;
converting said trace file blocks into source code expression blocks;
generating a plurality of minimal timing, compiled expression blocks, each of said plurality of minimal timing, compiled expression blocks corresponding to a respective one of said source code expression blocks, said generating including, for each source code expression block,
parameterizing said source code expression block to include at least one optimization parameter, the at least one optimization parameter being taken from parameters of self-tuning objects corresponding to entries in a trace file block from which said source code expression block was generated,
iteratively:
selecting at least one value for said at least one optimization parameter,
compiling said parameterized source code expression block in accordance with said selected at least one value for said at least one optimization parameter, and
measuring an execution time of object code resulting from that compiling, and,
on the basis of iteratively selecting, compiling and measuring, identifying the at least one value for said at least one optimization parameter that is associated with a minimal execution time for said compiled expression block; and,
linking said plurality of minimal timing, compiled expression blocks into said user program.

2. The method of claim 1, wherein said detecting said occurrences of expressions using said at least one self-tuning object in said user program is performed by program code associated with at least one overloaded operator associated with said at least one self-tuning object.

3. The method of claim 1, wherein said generating a trace file reflecting an execution flow of said expressions using said at least one self-tuning object in said user program is performed by program code associated with at least one overloaded operator associated with said at least one self-tuning object.

4. The method of claim 1, wherein said dividing said trace file into said plurality of trace file blocks is performed such that a total amount of computational dependencies and synchronization requirements within said user program, including computational dependencies and synchronization requirements between trace file blocks, are minimized.

5. The method of claim 1, wherein said dividing said trace file into said plurality of trace file blocks is performed responsive to user provided delimiters included within said user program.

6-7. (canceled)

8. The method of claim 1, wherein said linking of said minimal timing, compiled expression blocks to said user program is responsive to execution of said user program.

9. The method of claim 8, wherein said linking of said minimal timing, compiled expression blocks further comprises detecting, during said execution of said user program, corresponding occurrences of expressions using said at least one self-tuning object in said user program.

10. The method of claim 9, wherein said linking of said minimal timing, compiled expression blocks further comprises scheduling said minimal timing, compiled expression blocks for execution on at least one processor of a target parallel processing computer.

11. A computer program product including a computer readable medium, said computer readable medium having at least one computer program stored thereon, said at least one computer program comprising:
program code for receiving said user program;
program code for simulating execution of said user program;
program code for detecting, during said simulation of said execution of said user program, occurrences of expressions using said at least one self-tuning object in said user program;
program code for generating, for each occurrence in response to said detecting, an entry in a trace file including data representing said expressions and reflecting an execution flow of said expressions in said user program during said simulating and enabling generation of source code corresponding to said expressions;
program code for dividing said trace file into a plurality of trace file blocks;
program code for converting said trace file blocks into source code expression blocks;
program code for generating a plurality of minimal timing, compiled expression blocks, each of said plurality of minimal timing, compiled expression blocks corresponding to a respective one of said source code expression blocks, said generating including, for each source code expression block,
parameterizing said source code expression block to include at least one optimization parameter, the at least one optimization parameter being taken from parameters of self-tuning objects corresponding to entries in a trace file block from which said source code expression block was generated,
iteratively:
selecting at least one value for said at least one optimization parameter,
compiling said parameterized source code expression block in accordance with said selected at least one value for said at least one optimization parameter, and
measuring an execution time of object code resulting from that compiling, and,
on the basis of iteratively selecting, compiling and measuring, identifying the at least one value for said at least one optimization parameter that is associated with a minimal execution time for said compiled expression block; and,
program code for linking said plurality of minimal timing, compiled expression blocks into said user program.

12. The computer program product of claim 11, wherein said program code for detecting said occurrences of expressions using said self-tuning object in said user program comprises program code associated with at least one overloaded operator associated with said self-tuning object.

13. The computer program product of claim 11, wherein said program code for generating a trace file reflecting an execution flow of said expressions using said at least one self-tuning object in said user program comprises program code associated with at least one overloaded operator associated with said at least one self-tuning object.

14. The computer program product of claim 11, wherein said program code for dividing said trace file into said plurality of trace file blocks is operative to divide said trace file into said plurality of trace file blocks such that a total amount of computational dependencies and synchronization requirements within said user program, including computational dependencies and synchronization requirements between trace file blocks, are minimized.

15. The computer program product of claim 11, wherein said program code for dividing said trace file into said plurality of trace file blocks is operative to divide said trace file into said plurality of trace file blocks responsive to user provided delimiters included within said user program.

16-17. (canceled)

18. The computer program product of claim 11, wherein said program code for linking of said minimal timing, compiled expression blocks to said user program is triggered by execution of said user program.

19. The computer program product of claim 18, wherein said linking of said minimal timing, compiled expression blocks further comprises program code for detecting, during said execution of said user program, corresponding occurrences of expressions using said at least one self-tuning object in said user program.

20. The computer program product of claim 19, wherein said program code for linking of said minimal timing, compiled expression blocks further comprises program code for scheduling said minimal timing, compiled expression blocks for execution on at least one processor of a target parallel processing computer.

21. The computer program product of claim 11, wherein said computer program comprises a compiler.

22. A computer data signal embodied in a carrier wave, said computer data signal including at least one computer program, said at least one computer program comprising:
program code for receiving said user program;
program code for simulating execution of said user program;
program code for detecting, during said simulation of said execution of said user program, occurrences expressions using said at least one self-tuning object in said user program;
program code for generating, for each occurrence, in response to said detecting, an entry in a trace file including data representing said expressions and reflecting an execution flow of said expressions in said user program during said simulating and enabling generation of source code corresponding to said expressions;
program code for dividing said trace file into a plurality of trace file blocks;
program code for converting said trace file blocks into source code expression blocks;
program code for generating a plurality of minimal timing, compiled expression blocks, each of said plurality of minimal timing, compiled expression blocks corresponding to a respective one of said source code expression blocks, said generating including, for each source code expression block,
parameterizing said source code expression block to include at least one optimization parameter, the at least one optimization parameter being taken from parameters of self-tuning objects corresponding to entries in a trace file block from which said source code expression block was generated,
iteratively:
selecting at least one value for said at least one optimization parameter,
compiling said parameterized source code expression block in accordance with said selected at least one value for said at least one optimization parameter, and
measuring an execution time of object code resulting from that compiling, and,
on the basis of iteratively selecting, compiling and measuring, identifying the at least one value for said at least one optimization parameter that is associated with a minimal execution time for said compiled expression block; and,
program code for linking said plurality of minimal timing, compiled expression blocks into said user program.

23. A system for providing at least one self-tuning object to a user program, the system comprising:
at least one processor;
at least one memory communicably coupled to said at least one processor;
a computer program for execution on said processor, said computer program stored in said memory, said computer program comprising:
program code for receiving said user program;
program code for simulating execution of said user program;
program code for detecting, during said simulation of said execution of said user program, occurrences of expressions using said at least one self-tuning object in said user program;
program code for generating, for each occurrence, in response to said detecting, an entry in a trace file including data representing said expressions and reflecting an execution flow of said expressions in said user program during said simulating and enabling generation of source code corresponding to said expressions;
program code for dividing said trace file into a plurality of trace file blocks;
program code for converting said trace file blocks into source code expression blocks;
program code for generating a plurality of minimal timing, compiled expression blocks, each of said plurality of minimal timing, compiled expression blocks corresponding to a respective one of said source code expression blocks, said generating including, for each source code expression block,
parameterizing said source code expression block to include at least one optimization parameter, the at least one optimization parameter being taken from parameters of self-tuning objects corresponding to entries in a trace file block from which said source code expression block was generated,
iteratively:
selecting at least one value for said at least one optimization parameter,
compiling said parameterized source code expression block in accordance with said selected at least one value for said at least one optimization parameter, and
measuring an execution time of object code resulting from that compiling, and,
on the basis of iteratively selecting, compiling and measuring, identifying the at least one value for said at least one optimization parameter that is associated with a minimal execution time for said compiled expression block; and,
program code for linking said plurality of minimal timing, compiled expression blocks into said user program.

24. A system for providing at least one self-tuning object to a user program, comprising:
means for receiving said user program;
means for simulating execution of said user program;
means for detecting, during said simulating of said execution of said user program, occurrences of expressions using said at least one self-tuning object in said user program;
means for generating, for each occurrence, in response to said detecting, an entry in a trace file including data representing said plurality of expressions and reflecting an execution flow of said expressions in said user program during said simulating and enabling generation of source code corresponding to said expressions;
means for dividing said trace file into a plurality of trace file blocks;
means for converting said trace file blocks into source code expression blocks;
means for generating a plurality of minimal timing, compiled expression blocks, each of said plurality of minimal timing, compiled expression blocks corresponding to a respective one of said source code expression blocks, said generating including, for each source code expression block,
parameterizing said source code expression block to include at least one optimization parameter, the at least one optimization parameter being taken from parameters of self-tuning objects corresponding to entries in a trace file block from which said source code expression block was generated,
iteratively:
selecting at least one value for said at least one optimization parameter,
compiling said parameterized source code expression block in accordance with said selected at least one value for said at least one optimization parameter, and
measuring an execution time of object code resulting from that compiling, and,
on the basis of iteratively selecting, compiling and measuring, identifying the at least one value for said at least one optimization parameter that is associated with a minimal execution time for said compiled expression block; and,
means for linking said plurality of minimal timing, compiled expression blocks into said user program.
